(19) United States
(12) Patent Application Publication
(10) Pub. No.: US 2019/0034104 A1
(43) Pub. Date: Jan. 31, 2019

(54) NOTIFICATIONS IN STORAGE ARRAYS

(71) Applicant: Hewlett Packard Enterprise Development LP, Houston, TX (US)

(72) Inventors: Vivek Agarwal, Marlborough, MA (US); Rupin T. Mohan, Northborough, MA (US); Krishna Puttagunta, Rocklin, CA (US)

(21) Appl. No.: 16/077,124

(22) PCT Filed: Feb. 11, 2016
(86) PCT No.: PCT/US2016/017434

§ 371 Date: Aug. 10, 2018

(51) Int. Cl. G06F 3/06; G06F 13/16; G06F 13/42

(52) U.S. Cl. CPC G06F 3/0632; G06F 3/0604; G06F 2213/0036; G06F 13/1668; G06F 13/4282; G06F 3/0659

(57) ABSTRACT

An example system that includes a storage system controller to control a storage array. The storage system controller is to generate, in response to a logical unit change in the storage array, an in-band state change notification that includes in its payload an application-level-rescan-required notification.

### BACKGROUND

In a networked data storage system, computing devices may be connected to storage devices, such as hard disk drives, via a network, instead of having each computing device being directly connected to its own dedicated storage devices. Examples of such networked data storage systems include storage area networks (SANs) and network attached storage (NAS).

### BRIEF DESCRIPTION OF THE DRAWINGS

FIG. 1 is a conceptual diagram illustrating an example system.

FIG. 2 is a conceptual diagram illustrating another example system.

FIG. 3 is a conceptual diagram illustrating another example system.

FIG. 4 is a process flow diagram illustrating an example process.

FIG. 5 is a process flow diagram illustrating another example process.

FIG. 6 is a process flow diagram illustrating another example process.

FIG. 7 is a signal diagram illustrating example signaling.

### DETAILED DESCRIPTION

In a networked data storage system, the physical storage devices of the storage array may be partitioned into logical units (LUs), which constitute the logically distinct storage volumes that an initiator device reads data from and/or writes data to. A single physical storage device in the array may include a single LU or multiple LUs. Moreover, a single LU may span multiple physical storage devices, such as, for example, in a redundant array of independent disks (RAID) array. Thus, the number of LUs in the storage array may not necessarily correspond to the number of physical storage devices in the array, and new LUs may be added or existing LUs removed without adding or removing a physical storage device from the array.

When a change related to an LU occurs in the storage array, such as addition of a new LU to the array, the host computing devices are generally unware of the logical unit change. Various techniques including example systems, methods, and machine-readable media disclosed herein provide techniques for updating the host devices regarding such logical unit changes.

For example, various techniques including systems, methods, and machine-readable media are disclosed herein that are to, when a logical unit change occurs, automatically generate a notification that includes an instruction for initiator devices of the computing devices to initiate a SCSI bus rescan. In various examples disclosed herein, the notification is a state change notification (SCN) that is an in-band notification of a transport protocol being used by the network, and the instruction to initiate a bus rescan is included in the payload of the SCN. In various examples disclosed herein, an initiator device may, in response to receiving such a notification, request updated LU information from the storage array, and may initiate an application level rescan of the small computer system interface (SCSI) bus, making the updated information available to higher level drivers. Thus, the host computing devices are automatically updated about logical unit changes occurring on the storage array, without requiring an administrator to manually initiate a rescan.

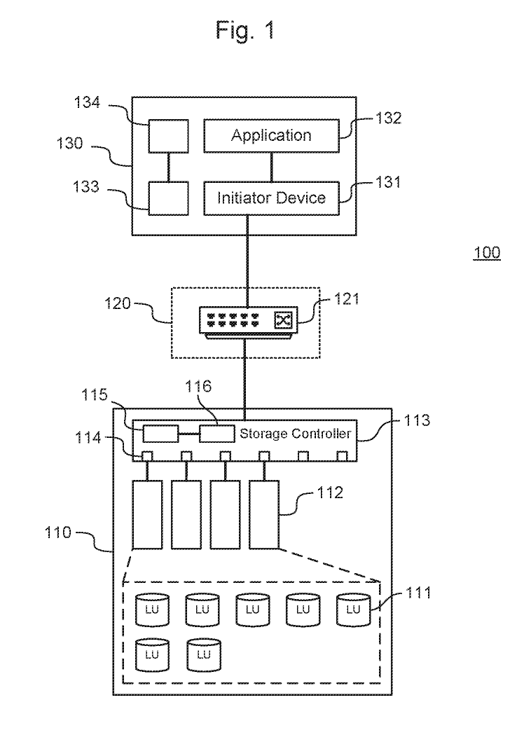

FIG. 1 illustrates an example networked data storage system 100. The example networked data storage system 100 includes a storage array 110, a network 120, and a host computing device 130. The host computing device 130 and storage array 110 are both connected to the network 120 such that the host computing device 130 is able to access the storage array 110. Although only one example storage array 110 and only one example host computing device are illustrated in FIG. 1, the system 100 may include any number of storage arrays 110 and host computing devices 130.

The example storage array 110 shown in FIG. 1 includes physical storage devices 112, logical units (LUs) 111, and storage controller 113. The physical storages devices 112 may include any data storage medium such as, for example, hard disk drives, tape drives, solid state drives, etc. The storage controller 113 controls the physical storage devices 112, and provides a communications interface between the physical storage devices 112 and the network 120.

The storage controller 113 may be, for example, a disk array controller, a RAID controller, a storage processor, a host bus adaptor (HBA), a target channel adaptor, a disk controller, etc. The storage controller 113 may include ports 114, and the physical storage devices 112 may be connected to the storage controller via the ports 114. The storage controller 113 may process SCSI commands received from host computing systems 130, and may manage data read/write from/to the LUs 111 based on the received commands. The storage controller 113 may also transmit messages to the network 120, such as notifications defined by a transport protocol of the network 120. The storage controller 113 may divide the storage volumes of the physical storage devices 112 into LUs 111, assign communications paths (physical and/or logical) to the LUs 111, and may make the LUs 111 available to the host computing systems 130. Example transport protocols include fibre channel protocol (FCP), internet small computer system interface (iSCSI), fibre channel over IP (FC/IP), internet fibre channel protocol (iFCP), HyperSCSI, fiber channel over Ethernet (FCoE), etc

In particular, the storage controller 113 may add a new LU 111, remove an existing LU 111, change the volume of an existing LU, add a new path to an LU 111, change an existing path to an LU 111, and remove an existing path to an LU 111. The forgoing are examples of logical unit changes (described further below). Such logical unit changes may be performed in response to instructions received, for example, from a system administrator, who may control the storage controller 113 via a user interface (not illustrated). The logical unit changes may also be initiated automatically, for example, by an application that monitors storage needs of the connected host computing devices 130 and re-provisions LUs 111 in response thereto.

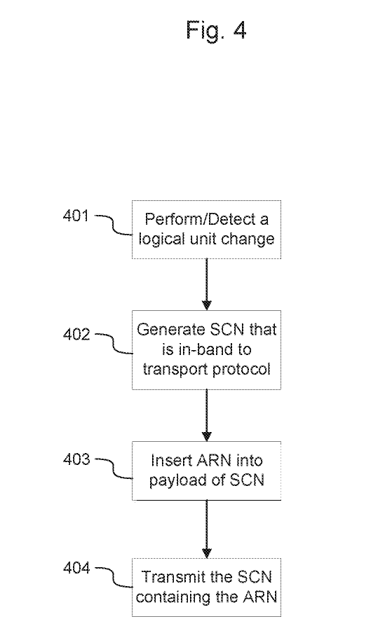

The storage controller 113 also executes processes for generating a notification in response to logical unit changes, such as the example process illustrated in FIG. 4 (described in greater detail below). For example, in response to a logical unit change, the storage controller 113 may generate an SCN that is in-band to a transport protocol being used by the network 120, and may insert into a payload of the SCN an instruction to perform an application level bus rescan. The instruction to perform an application level bus rescan may be referred to herein as an application-level-rescan-notification (ARN). The ARN may be any type of indicator that would be interpreted by an initiator device 131 as a request to initiate an application level bus rescan.

In the example described above, the notification generated by the storage controller 113 may be an SCN of a transport protocol being used by the network 120. An SCN is an in-band notification related to reporting state changes of network end-points. Some transport protocols define some form of SCN, which may have different formats and/or naming conventions depending on the protocol. For example, the Fibre Channel Protocol (FCP) includes a Registered State Change Notification (RSCN) as a form of SCN. As another example, the iSCSI protocol includes an Internet Storage Name Service—State Change Notification (iSNS-SCN) message. However, regardless of the different formats and naming conventions, the SCNs all include a payload portion in which the sender of the notification may include information related to the nature of the state change that prompted the message. The SCNs may also include information indicating that the message is an SCN as well as the identity of the network end-point that generated the notification. Such an SCN may be sent by a network end-point to a network device (for example, a switch), and from the network device the notification may be forwarded to other relevant network end-points (for example, a host computing device). For example, in an FCP network a network device that receives an RSCN will forward it to those network end-points that have previously registered with the network device to receive RSCNs from the device that generated the RSCN. Reference herein to the SCN being “in-band” means that the SCN is a notification that is defined by a transport protocol being used by the network 120.

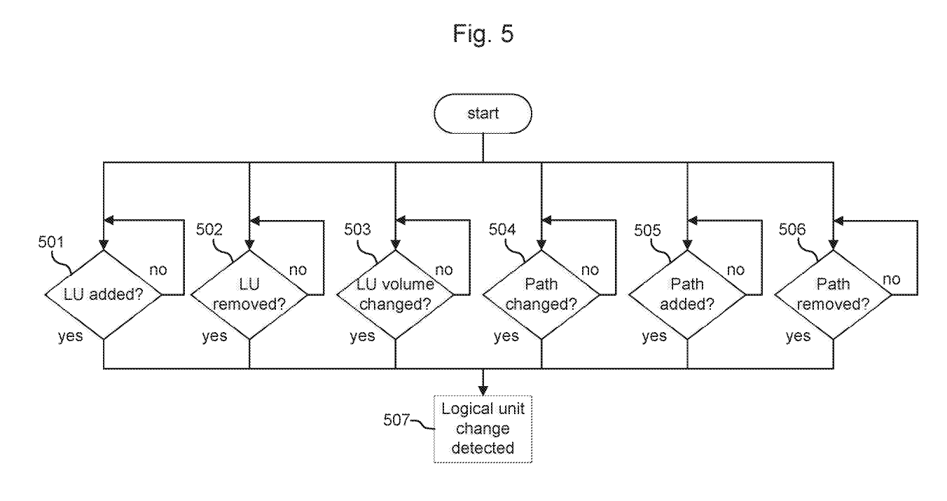

The storage controller 113 may include processing circuitry 115 and a storage medium 116. The storage medium 116 may store machine-readable instructions that, when executed by the processing circuitry 115, direct or cause the storage controller 113 to execute certain of the operations described herein, such as, for example, the operations described in the example processes of FIGS. 4 and 5. The processing circuity 115 may be any hardware that can retrieve machine-readable instructions from the storage medium 116 and execute the instructions, such as, for example, a central processing unit (CPU), microprocessor, micro-controller or the like. The storage medium 116 may be any electronic, magnetic, optical, or other physical storage device that stores executable instructions. Thus, storage medium 116 may be, for example, Random Access Memory (RAM), an Electrically-Erasable Programmable Read-Only Memory (EEPROM), a storage drive, an optical disc, and the like.

The storage array 110 shown in FIG. 1 is merely one example, and it is to be understood that more or fewer of the illustrated components may be included, and the components may be arranged in different configurations. For example, any arbitrary numbers of ports 114, physical storage devices 112, LUs 111, processing circuitry 115, and storage media 116 may be included in the storage array 110. Furthermore, additional components besides those illustrated in the example of FIG. 1 may be included in the storage array 110, such as, for example, communications buses, I/O units, etc. The storage array 110 may be housed in a single chassis, but this need not necessarily be the case; for example, the storage controller 113 may be included in a first chassis (for example, in a server) while the physical storage devices 112 may be included in a second chassis (for example, an HDD rack). Moreover, the processing circuity 115 and/or the storage medium 116 need not necessarily be exclusive to the storage controller 113—these components may be shared by other devices, systems, or components besides the storage controller 113, and may be located as part of a different module or device package than the rest of the components of the storage controller 113.

The network 120 in the example system 100 may include a network device 121 that is part of a communications path that connects the storage array 110 with the host computing device 130. FIG. 1 illustrates the network device 121 as being a switch for simplicity, but it will be understood that any other type of network device 121 may be included in the network 120 in addition to or in lieu of the switch, such as routers, bridges, gateways, servers, repeaters, and so on. The network 120 may be, for example, a Fibre Channel fabric, an IP network, an Ethernet network, a hybrid of these networks, or any other type of network. In addition, the network 120 may include multiple parts (sub-networks) that may have distinct structures and/or protocols; for example, a Fibre Channel fabric that is local to the storage array 110 may form a first sub-network that is connected to a second sub-network comprising an IP based wide-area-network that is connected to a third sub-network comprising a local-area-network that includes the host computing device 130. The network 120 may transport messages between the host computing devices 130 and the storage array 110 using transport protocols such as, for example, FCP, iSCSI, FC/IP, iFCP, HyperSCSI, FCoE, etc. More than one transport protocol may be used by the network 120; for example, a network 120 including an FC sub-network and an IP sub-network may use FCP on the FC sub-network and TCP on the IP sub-network, with a gateway translating between the protocols.

The host computing device 130 may have an application 132 and an initiator device 131 that is to communicate with the storage array 110. The application 132 may be any entity hosted on the computing device 130 that accesses the storage array 110, including, for example, a disk driver, a VMFS driver, etc. The initiator device 131 is an interface between the application 132 and the storage controller 113, and may, for example, convert or translate instructions from the application 132 into commands that the storage controller 113 can process or understand (for example, SCSI commands), and transmit these commands and any related data to the network 120 via the relevant protocol of the network 120. For example, if the application 132 wants to write data to the storage array, the initiator device may generate a write command and encapsulate the command and the data for transmission to the network 120 according to a transport protocol. The initiator device 131 may be, for example, an SCSI driver, host adaptor, host bus adaptor (HBA), or the like.

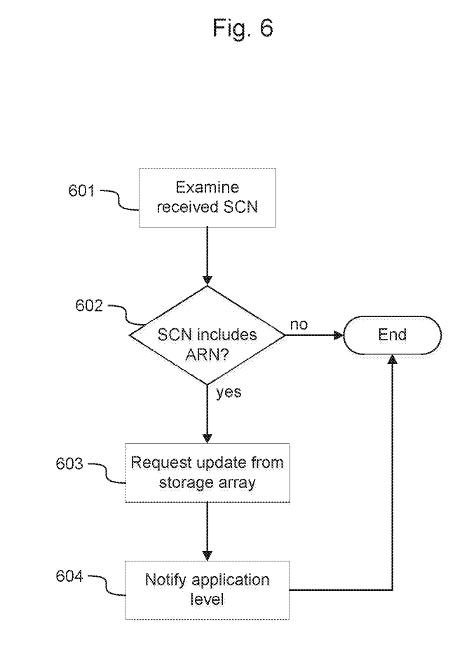

The initiator device 131 may be also to receive messages from the network, such as SCNs. In particular, the initiator device 131 may receive an SCN that has the ARN in its payload. In response to receiving the SCN containing the ARN, the initiator device 131 may perform processes for initiating a bus rescan, such as the example process of FIG. 6 (discussed in greater detail below). For example, in response to receiving the SCN, the initiator device 131 may initiate a bus rescan by requesting updated information about the LUs 111, for example, the initiator device may send REPORT LUN and LUN INQUIRY commands to the storage array 110. The storage array 110 may respond to the REPORT LUN and LUN INQUIRY with information about the LU 111 that experienced the logical unit change, and thus the initiator device 131 is notified or made aware of the logical unit change. The initiator device 131 may then automatically notify the application level of the change through, for example, return status to the application 132 or based upon global flag.

The host computing device 130 may include processing circuitry 133 and a storage medium 134. The storage medium 134 may store machine-readable instructions that, when executed by the processing circuitry 133, direct or cause the host computing device 130 to execute certain of the operations described herein, such as, for example, the operations described in the process of FIG. 6. The processing circuity 133 may be any hardware that can retrieve machine-readable instructions from the storage medium 134 and execute the instructions, such as, for example, a central processing unit (CPU), microprocessor, micro-controller or the like. The storage medium 134 may be any may be any electronic, magnetic, optical, or other physical storage device that stores executable instructions. Thus, storage medium 134 may be, for example, Random Access Memory (RAM), an Electrically-Erasable Programmable Read-Only Memory (EEPROM), a storage drive, an optical disc, and the like. Moreover, the processing circuity 133 and/or the storage medium 134 may be associated with the initiator device 131 and these components may be shared by other devices, systems, or components besides the initiator device 131, and may be located as part of a different module or device package than the rest of the components of the initiator device 131.

As described above, in the example system 100 the storage controller 113 may be able to automatically generate the SCN with the ARN embedded in its payload when a logical unit change occurs, which may cause the initiator device 131 to automatically initiate a bus rescan to obtain updated LU 111 information. Thus, the example system 100 may be able to automatically update the host computing devices 130 regarding logical unit changes, without requiring the manual initiation of a bus rescan by a system administrator. In addition, because the SCN is in-band to the transport protocol being used by the network, the initiator device 131 obtains the updated information in real time. This is in contrast to, for example, using a separate “out-of-band” agent for monitoring for logical unit changes and generating “out-of-band” notifications, which may require a longer delay between detection of a logical unit change and updated information being received by the host computing devices 130. In addition, by having the storage controller 113 generate the in-band SCN, it reduces the need to install a special “out-of-band” agent for monitoring for logical unit changes and generation out-of-band notifications, thus reducing complexity of the system and saving time and money, etc. Furthermore, the in-band notification and discovery processes described herein may be less susceptible to errors than an “out-of-band” notification and discovery solution.

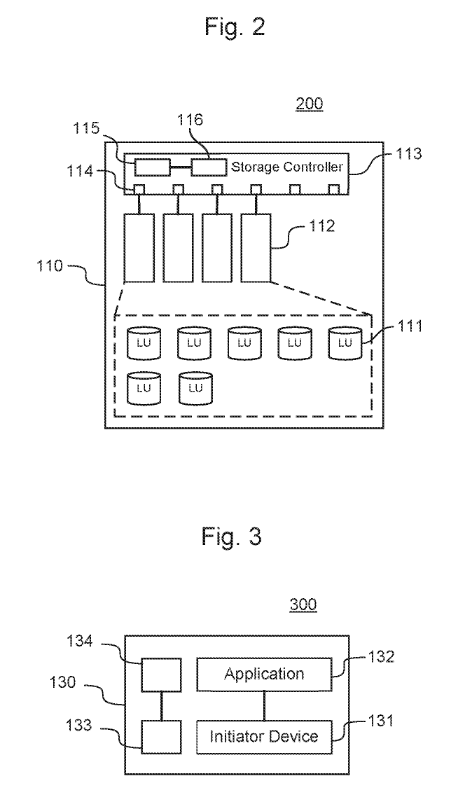

FIG. 2 illustrates an example system 200. Those components in the system 200 that are the same as components in the system 100 are given the same reference signs, and duplicative description thereof is omitted. The example system 200 includes a storage array 110 that has a similar configuration as the storage array 110 of the example system 100, but the network 120 and the host computing device 130 are not included as part of the system 200. The storage array 110 of the system 200 is connectable to a network (such as the network 120) via the storage controller 113, and the storage array 110 may be made accessible to a host computing device (such as the computing device 130) through such a network. The storage array 110 is configured to, if the storage array 110 is connected to a network and there is a logical unit change on the storage array 110, generate an SCN containing the ARN in response to the logical unit change. The storage array 110 of the system 200 may execute processes similar to those described above with respect to storage array 110 of the system 100, and thus duplicative description will be omitted. For example, the storage array 110 of the system 200 may execute the example processes of FIGS. 4 and 5 (described below).

FIG. 3 illustrates another example system 300. Those components in the system 300 that are the same as components in the system 100 are given the same reference signs, and duplicative description thereof is omitted. The example system 300 includes a host computing device 130 that has a similar configuration as the host computing device 130 of the example system 100, but the network 120 and the storage array 110 are not included as part of the system 300. The host computing device 130 of the system 300 is connectable to a network (such as the network 120) via the initiator device 131, and the host computing device 130 is capable of accessing a storage array (such as the storage array 110) via such a network. The host computing device 130 is configured to, if the host computing device 130 receives an SCN containing the ARN from a network, initiate an application level bus rescan. The computing device 130 of the system 300 may execute processes similar to those described above with respect to computing device 130 of the system 100, and thus duplicative description will be omitted. For example, the computing device 130 of the system 300 may execute the example process of FIG. 5 (described below).

FIG. 4 illustrates an example process for generating an SCN containing the ARN. The example process of FIG. 4 may be performed, for example, by a storage system controller (such as the storage system controller 113). Moreover, machine-readable instructions may be stored on a storage medium (for example, storage medium 116) that, when executed by processing circuitry (for example, the processing circuitry 115), cause the processing circuitry to execute operations corresponding to the example process of FIG. 4.

In block 401 of the example process, a logical unit change is performed and/or detected, and in response to this performance/detection the process proceeds to blocks 402-404. As used herein and in the appended claims, a “logical unit change” includes any one of the following: a new LU 111 is added, an existing LU 111 is removed, the volume of an existing LU is changed, a new path to an LU 111 is added, an existing path to an LU 111 is changed, and an existing path to an LU 111 is removed. As an example of how the operations of block 401 may be implemented, respective processing routines or processes for performing the logical unit changes may each include instructions to execute operations corresponding to blocks 402-404, such that when the storage system controller 113 performs one of the logical unit changes it also automatically performs operations corresponding to blocks 402-404. As another example, instead of including instructions for blocks 402-404 in each of the individual routines for performing the respective logical unit changes, a separate routine for monitoring to detect logical unit changes may be executed.

FIG. 5 illustrates one example of such a process for detecting a logical unit change. In the example of FIG. 5, decision blocks 501, 502, 503, 504, 505, and 506, are executed (concurrently or sequentially), and in each of the decision blocks 501, 502, 503, 504, 505, and 506 it is determined whether a specified event corresponding to one of the example logical unit changes described above has occurred since a last time the decision block was executed. If the answer to any of the decision blocks 501, 502, 503, 504, 505, and 506 is yes, then the process proceeds to step 507, and a logical unit change has been detected. If the answer to all of the decision blocks 501, 502, 503, 504, 505, and 506 is no, then the process loops around and the decisions blocks are considered again. The decision blocks 501, 502, 503, 504, 505, and 506 may be re-considered, for example, after a set period of time, or in response to the occurrence of a specified event. The example of FIG. 5 is merely one example of how a logical unit change can be detected in block 401, and any other possible method of detecting a logical unit change can be used. For example, the storage controller 113 may set a flag any time that it adds a new LU 111, removes an existing LU 111, changes the volume of an existing LU, adds a new path to an LU 111, changes an existing path to an LU 111, or removes an existing path to an LU 111, and this flag may be detected as indicating a logical unit change.

In response to a logical unit change being performed and/or detected in block 401, in block 402 an SCN that is in-band to a transport protocol being used by the network 120 is generated. As described above, as used herein “in-band” means that the SCN is a notification that is defined by a transport protocol being used by the network 120.

In block 403, the application-level-rescan-required notification (ARN) is inserted into the payload of the SCN. As described above, the ARN may be any type of indicator that would be interpreted by an initiator device as a request to initiate an application level bus rescan. For example, a specific code (sequence of bits or bytes) may be an ARN if the code, in the context of the payload of an SCN, is recognizable by an appropriately enabled initiator device as a request to initiate an application level bus rescan. In such an example, there is no requirement that any appropriately enabled initiator device actually receive the SCN containing the code for the code to be considered an ARN; that there exists an initiator device that could recognize the code, in the context of an SCN's payload, as a request to initiate a bus rescan if the device were to receive such an SCN is sufficient for the code to be considered an ARN. As another example, a technical specification may define a specific code (sequence of bits or bytes) as an ARN, such that an initiator device that is compliant with the technical specification would interpret an SCN containing the code in its payload as a request to initiate a bus rescan. In this example, it is irrelevant whether any initiator device actually exists that complies with the technical specification.

In block 404, the SCN containing the ARN may be transmitted to the network 120. Although the operations of blocks 402 through 404 are presented in the example process in sequential conceptual blocks, these operations may be performed concurrently—for example, the SCN may be generated by transmitting bits of the SCN (i.e., generation and transmission may be simultaneous) and the ARN may be inserted into the SCN as the SCN is being transmitted by, when the payload portion of the SCN is reached, transmitting bits corresponding to the ARN as the payload bits.

FIG. 6 illustrates an example process for handling a received SCN that contains an ARN. The example process may be performed, for example, by an initiator device 131 of a host computing system 130. Moreover, the process of FIG. 6 may be performed as a result of processing circuitry executing instructions stored on a non-transitory machine-readable medium. For example, the storage medium 134 may store machine-readable instructions corresponding to the process of FIG. 6, and the processing circuitry 133 may execute the instructions to perform operations corresponding to the process of FIG. 6.

In block 601 of the example process of FIG. 6, a state change notification (SCN) is received from a network and is examined. For example, the examining of the message may include identifying the message as being a SCN, and identifying a payload portion of the SCN.

In decision bock 602, it is determined whether the payload portion of the received SCN includes the ARN. If the SCN does not include the ARN in its payload, then the example process may end. If the SCN does include the ARN in its payload, then the process proceeds to block 603.

In block 603, in response to determining that the received SCN includes the ARN, an application level bus rescan is initiated. As part of the bus rescan, updated information is requested from the storage array 110. The rescan may be, for example, a VMFS rescan operation. For example, the initiator device 131 may send to the storage array 110 REPORT LUN and LUN INQUIRY commands. The REPORT LUN command requests the logical unit numbers (LUNs) of the LUs 111 currently included in the storage array 110, and the LUN INQUIRY command requests status information of the LUs 111. The storage array 110 sends a response that includes updated information for the LU 111 that experienced the logical unit change, and thus the initiator device 131 is notified or made aware of the logical unit change.

In block 604, the application level is made aware of the logical unit change. For example, rescan communication to upper level drivers can be through return status or based upon global flag.

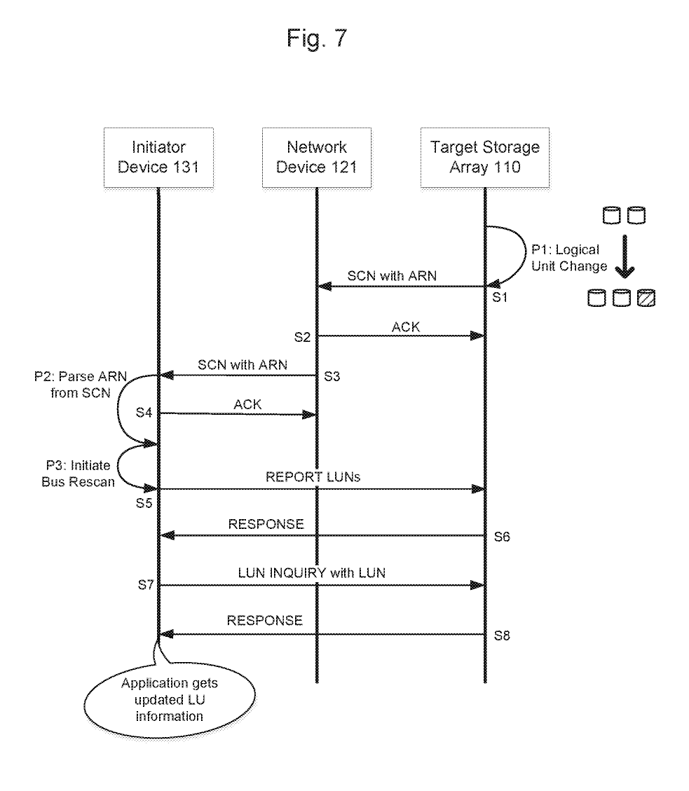

FIG. 7 is a signaling/processing diagram, which illustrates an example message exchange in the example system 100 resulting from a logical unit change. At P1, a logical unit change is performed, for example, a new LU 111 is added. In response to the logical unit change, at S1 an SCN containing an ARN is sent from the storage array 110 to the network device 121. At S2, the network device 121 sends an acknowledge signal ACK to the storage array 110. At S3, the network device 121 forwards the SCN with ARN to the initiator device 131. For example, if the SCN is an RSCN, then the initiator device 131 will need to have registered in advance with the network device 121 to receive RSCNs from the storage array 110; in addition, the RSCN would be forwarded to any other initiator devices 131 that had similarly registered to receive RSCNs from the storage array 110. In response to receiving the SCN, the initiator device 131 sends an acknowledge message ACK at S4, and at P2 parses the SCN to determine that it contains the ARN. In response to determining that the SCN contains the ARN, the initiator device 131 initiates an application level bus rescan at P3. The initiation of the application level bus rescan may include sending a REPORT LUNS command to the storage array 110 at S5. At S6 the storage array sends a RESPONSE that includes the LUNs of the LUs 111 currently included in the storage array 110. At S7, the initiator device may send a LUN INQUIRY to the storage array 110. At S8, the storage array sends a response message RESPONSE that includes, among other things, information about the LU 111 that experienced the logical unit change. Thus, the application is able to obtain the updated information about the LUs 111.

The foregoing describes storage techniques. While the above disclosure has been shown and described with reference to the foregoing examples, it should be understood that other forms, details, and implementations may be made without departing from the spirit and scope of this disclosure.

What is claimed is:

1. A system comprising:
a storage system controller to control a storage array,
wherein the storage system controller is to generate, in response to a logical unit change in the storage array, an in-band state change notification that includes in its payload an application-level-rescan-required notification.

2. The system of claim 1,
wherein the logical unit change comprises a logical unit being added to the storage array.

3. The system of claim 1,
wherein the logical unit change comprises a logical unit being removed from the storage array.

4. The system of claim 1,
wherein the logical unit change comprises a volume of a logical unit of the storage array being changed.

5. The system of claim 1,
wherein the logical unit change comprises a path to a logical unit of the storage array being added, removed, or changed.

6. The system of claim 1, further comprising:
an initiator device that is to, in response to receiving the state change notification that includes in its payload the application-level-rescan-required notification, initiate a SCSI bus rescan.

7. The system of claim 1,
wherein the in-band state change notification is an RSCN of a transport layer protocol.

8. A non-transitory machine-readable medium that stores instructions that when executed by a processor cause a driver of a computing device that is connected to a storage array to:
determine whether an in-band state change notification received from the storage array includes in its payload an application-level-rescan-required notification; and
if the state change notification includes in its payload the application-level-rescan-required notification, initiate an SCSI bus rescan.

9. The non-transitory machine-readable medium of claim 8,
wherein the instructions are to cause the SCSI driver to notify a host application of the computing device about any modifications detected via the rescan.

10. The non-transitory machine-readable medium of claim 8,
wherein the state change notification is an RSCN of a transport layer protocol.

11. A method, comprising:
determining that a logical unit change has occurred in a storage array connected to a network; and
in response to the logical unit change, transmitting a state change notification to the network, wherein the state change notification is in-band to a network level protocol being used by the network and includes in its payload an application-level-rescan-required notification.

12. The method of claim 11,
wherein the logical unit change comprises a logical unit being added to the storage array.

13. The method of claim 11,
wherein the logical unit change comprises a logical unit being removed from the storage array.

14. The method of claim 11,
wherein the logical unit change comprises a volume of a logical unit of the storage array being changed.

15. The method of claim 11,
wherein the logical unit change comprises a path to a logical unit of the storage array being added, removed, or changed.
